(19) United States
(12) Patent Application Publication
(10) Pub. No.: US 2006/0085444 A1
(43) Pub. Date: Apr. 20, 2006

(54) Query consolidation for retrieving data from an OLAP cube

(75) Inventors: Nina Sarawgi, Sammamish, WA (US); Lakshmi Narayanan Thanu, Sammamish, WA (US); Xiaohong Yang, Sammamish, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 10/969,367

(22) Filed: Oct. 19, 2004

(51) Int. Cl. G06F 17/30

(52) U.S. Cl. 707/100

(57) ABSTRACT

Queries to obtain data from an OLAP cube are consolidated. Queries are consolidated to reduce the number of database hits to retrieve data from an OLAP cube. Instead of querying the OLAP cube for each cell in a free-form report, a consolidated query is used to obtain the desired information. The consolidated query may contain requests for data from different dimensions within the OLAP cube. The cells in the spreadsheet are parsed to determine the dimensions of the OLAP cube that are used within the spreadsheet cell. A list of dimensions accessed by the spreadsheet cells is compiled and the query is constructed by adding default dimensions to each cell as necessary to complete the query.

### BACKGROUND OF THE INVENTION

Online analytical processing (OLAP) is an integral part of most data warehouse and business analysis systems. OLAP services provide for fast analysis of multidimensional information. For this purpose, OLAP services provide for multidimensional access and navigation of the data in an intuitive and natural way, providing a global view of data that can be “drilled down” into particular data of interest. Speed and response time are important attributes of OLAP services that allow users to browse and analyze data online in an efficient manner. Further, OLAP services typically provide analytical tools to rank, aggregate, and calculate lead and lag indicators for the data under analysis.

In OLAP, information is viewed conceptually as cubes, consisting of dimensions, levels, and measures. In this context, a dimension is a structural attribute of a cube that is a list of members of a similar type in the user's perception of the data. Typically, there are hierarchy levels associated with each dimension. For example, a time dimension may have hierarchical levels consisting of days, weeks, months, and years, while a geography dimension may have levels of cities, states/provinces, and countries. Dimension members act as indices for identifying a particular cell or range of cells within a multidimensional array. Each cell contains a value, also referred to as a measure, or measurement. A query is created to access the data within the cube. It is important that this access be performed in an efficient manner.

### SUMMARY OF THE INVENTION

Embodiments of the present invention are related to a method and system for consolidating queries to obtain data from an OLAP cube.

According to one aspect of the invention, queries to retrieve data from an OLAP cube are consolidated to reduce the number of database hits. Instead of querying the OLAP cube for each cell within a free-form report, a single query is used to obtain the desired information from the cube.

According to another aspect of the invention, each spreadsheet cell is parsed to determine all of the dimensions of the OLAP cube that are used within the spreadsheet cells. A list of the accessed dimensions is compiled and the query is constructed by adding default dimensions to each cell as necessary to complete the query.

### BRIEF DESCRIPTION OF THE DRAWINGS

FIG. 1 is an exemplary computing device that may be used in exemplary embodiments of the present invention;

FIG. 2 illustrates a query consolidation system;

FIG. 3 illustrates an exemplary OLAP cube;

FIG. 4 illustrates a free-form report;

FIG. 5 illustrates a process for consolidating a query; and

FIG. 6 illustrates a process for creating tuples to identify data within an OLAP cube, in accordance with aspects of the invention.

### DETAILED DESCRIPTION OF THE PREFERRED EMBODIMENT

In the following detailed description of exemplary embodiments of the invention, reference is made to the accompanied drawings, which form a part hereof, and which is shown by way of illustration, specific exemplary embodiments of which the invention may be practiced. These embodiments are described in sufficient detail to enable those skilled in the art to practice the invention, and it is to be understood that other embodiments may be utilized, and other changes may be made, without departing from the spirit or scope of the present invention. The following detailed description is, therefore, not to be taken in a limiting sense, and the scope of the present invention is defined only by the appended claims.

Throughout the specification and claims, the following terms take the meanings associated herein, unless the context clearly dictates otherwise. The term “cube” refers to a set of data that is organized and summarized into a multidimensional structure defined by a set of dimensions and measures.

The term “dimension” refers to a structural attribute of a cube, which is an organized hierarchy of categories (levels) that describe data in a fact table. These categories typically describe a similar set of members upon which the user wants to base an analysis. For example, a geography dimension might include levels for Country, Region, State or Province, and City.

The term “hierarchy” refers to a logical tree structure that organizes the members of a dimension such that each member has one parent member and zero or more child members.

The term “level” refers to the name of a set of members in a dimension hierarchy such that all members of the set are at the same distance from the root of the hierarchy. For example, a time hierarchy may contain the levels Year, Month, and Day.

The term “measure” refers to values within a cube that are based on a column in the cube's fact table store and are usually numeric. Measures are the central values that are aggregated and analyzed.

The term “member” refers to an item in a dimension representing one or more occurrences of data. A member can be either unique or non-unique. For example, 1997 and 1998 represent unique members in the year level of a time dimension, whereas January represents non-unique members in the month level because there can be more than one January in the time dimension if the cube contains data for more than one year.

The term “OLAP” refers to Online Analytical Processing. OLAP is a technology that uses multidimensional structures to provide rapid access to data for analysis. The source data for OLAP is commonly stored in data warehouses in a relational database.

The term “tuple(s)” refers to an ordered collection of members from different dimensions. For example, (Boston, [1995]) is a tuple formed by members of two dimensions: Geography and Time.

Consolidated Query System Level Overview

Generally, embodiments of the present invention are related to a method and system for consolidating queries to retrieve data from an OLAP cube such that the number of database hits is reduced. Instead of querying the OLAP cube for each cell of a free-form report that uses data from the cube, a consolidated query is constructed and is used to obtain the desired data from the cube. Cells within the spreadsheet are parsed to determine all of the dimensions of the OLAP cube that are used within the spreadsheet cells. A list of the accessed dimensions is compiled and the query is constructed by adding default dimensions to each cell as necessary to complete the query.

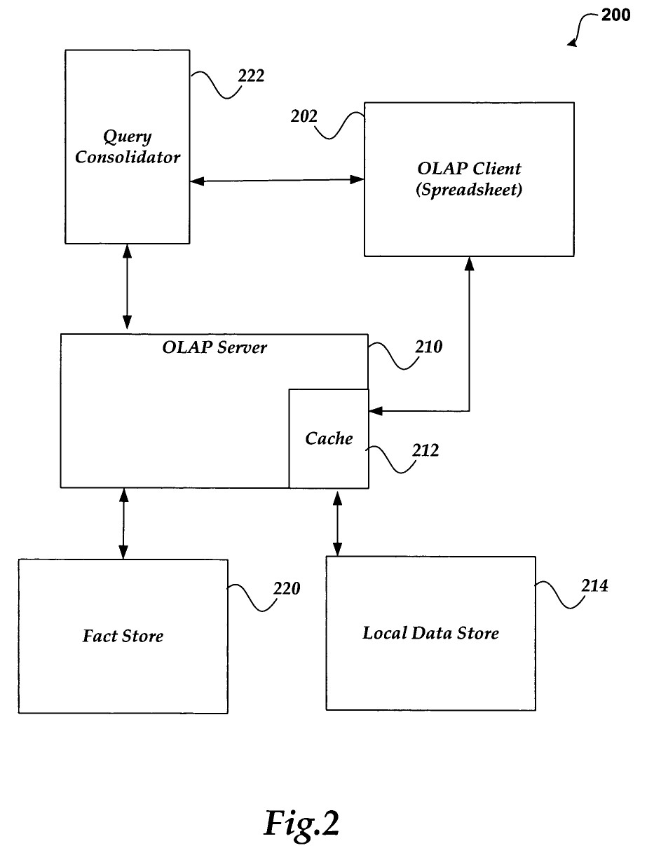

FIG. 2 illustrates a query consolidation system, in accordance with aspects of the present invention. As illustrated, the system includes OLAP client 202, query consolidator 222, OLAP server 210, local data store 214, and fact data store 220, all of which may interact with the data within an OLAP cube(s).

OLAP client 202 is an application program that uses the services of an OLAP system. OLAP client 202 may be any type of application that interacts with the OLAP system and queries an OLAP cube for data. For example OLAP client 202 may be a spreadsheet, a data mining application, a data warehousing application, a reporting application, and the like. According to one embodiment of the invention, OLAP client 202 is a spreadsheet program, such as the Excel® spreadsheet program by Microsoft Corporation. OLAP client 202 typically interacts with OLAP server 210 by issuing OLAP queries requesting data from a cube. These queries are parsed into a request for data from the cube, and the request is passed to the OLAP server 210.

Query consolidator 222 interacts with OLAP client 202 and OLAP server 210. According to one embodiment, query consolidator 222 is a plug-in to client application 202. According to another embodiment, the functionality of query consolidator 222 may be included within client 202 or some other program. Consolidator 222 accesses a spreadsheet (202) and generates a consolidated query to access the cube data referenced within the spreadsheet. Generally, consolidator 222 accesses each cell within spreadsheet 202 and determines each of the cells that accesses OLAP data. For each spreadsheet cell that accesses OLAP data a tuple is generated to identify data within an OLAP cube. According to one embodiment, the number of members within each tuple is constanst across spreadsheet cells. For example, if a total of six cube dimensions are accessed by cells within the spreadsheet, then each tuple will contain six members. When the spreadsheet cell does not access a particular dimension, a default member is placed within the tuple. Once the tuples are created, query consolidator 222 consolidates the tuples to form a consolidated query to access the cube data and reduce the number of hits. Instead of hitting the OLAP cube for each cell within the spreadsheet, the cube is hit fewer times, thereby reducing the time required to obtain the data from the cube. According to one embodiment, each of the queries that identify data from a single cell within a cube are consolidated into a single query. According to another embodiment of the invention, the consolidated query consolidates at least two queries from the spreadsheet cells. Consolidator 222 may also maintain a mapping table which maps the retrieved data to the cells within the spreadsheet. Consolidator 222 submits the consolidated query to OLAP server 210.

OLAP server 210 receives the query and controls the processing of the query. In one embodiment of the invention, OLAP server 210 maintains a local data store 214 that contains the data used to answer queries. In one embodiment of the invention, the OLAP server 210 is a version of the SQL Server OLAP product from Microsoft Corporation.

Local data store 214 contains records describing the cells that are present in a multidimensional database, with one record used for each cell that has measurement data present (i.e. no records exist for those cells having no measurement data). In an embodiment of the invention, local data store 214 is a relational database, such as SQL Server. In alternative embodiments of the invention, database systems such as Oracle, Informix or Sybase can be used. The invention is not limited to any particular type of relational database system.

OLAP server 210 populates local data store 214 by reading data from fact data store 220. Fact data store 220 is also a relational database system. In one embodiment of the invention, the system used is the SQL Server Database from Microsoft Corporation. In alternative embodiments of the invention, any type of relational database system may be used. For example, database systems such as Oracle, Informix or Sybase can be used.

According to one embodiment, records are stored in a relational table. This table can be indexed based on the dimensional paths of the record to allow rapid access to cell measurement data contained in the record.

In one embodiment of the invention, OLAP server 210 maintains a cache 212 of records. In this embodiment, cache 212 maintains data records that have been recently requested, or those data records that are frequently requested. Maintaining cell record data in a cache may help provide quicker responses to queries that can be satisfied by records appearing in the cache.

Exemplary Cube and Dimension

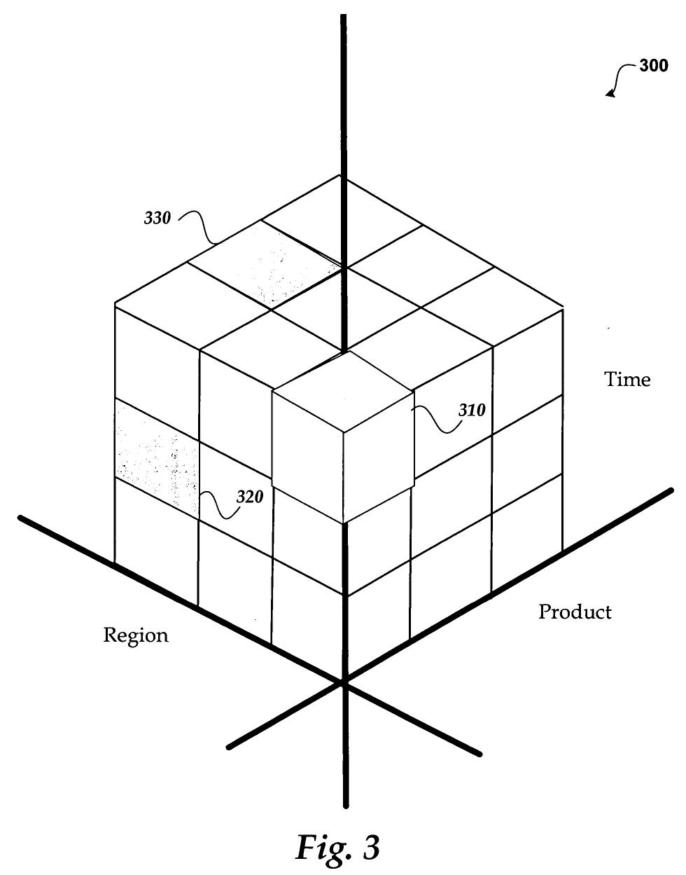

FIG. 3 illustrates an exemplary OLAP cube, in accordance with aspects of the present invention.

In an OLAP data model, information is viewed conceptually as cubes that consist of descriptive categories (dimensions) and quantitative values (measures). The multidimensional data model makes it easier for users to formulate complex queries, arrange data on a report, switch from summary to detail data, and filter or slice data into meaningful subsets. For example, typical dimensions in a cube containing sales information may include time, geography, product, channel, organization, and scenario (budget or actual). Typical measures may include dollar sales, unit sales, inventory, headcount, income, and expense.

Within each dimension of an OLAP data model, data can be organized into a hierarchy that represents levels of detail on the data. For example, within the time dimension, there may be levels for years, months, and days. Similarly, a geography dimension may include: country, region, state/province, and city levels. A particular instance of the OLAP data model would have the specific values for each level in the hierarchy. A user viewing OLAP data can move up or down between levels to view information that is either more or less detailed.

The cube is a specialized database that is optimized to combine, process, and summarize large amounts of data in order to provide answers to questions about that data in the shortest amount of time. This allows users to analyze, compare, and report on data in order to spot business trends, opportunities, and problems. A cube uses pre-aggregated data instead of aggregating the data at the time the user submits a query.

Hierarchies and levels can be defined for dimensions within the cube. Hierarchies typically display the same data in different formats such as time data can appear as months or quarters. Levels typically allow the data to be “rolled up” into increasing less detailed information such as in a Region dimension where cities roll-up into states which roll-up into regions which roll-up into counties and so forth. This allows the user to “drill-up” or “drill-down” to see the data in the desired detail. Levels and hierarchies for a star schema are derived from the columns in a dimension table. In a snowflake schema, they are typically derived from the data in related tables.

The exemplary OLAP cube illustrated includes three dimensions. The Region dimension may many different levels. For example, the region dimension may include a country level, a geographic area level (NE, NW, SE, SW, and the like), and a city level. The Products dimension may also include multiple levels. For example, has all, category and product. Finally, the third dimension, the Time dimension may include multiple levels, such as year, quarter, and month). The cube may also include multiple measures. For example, unit sales and purchases. This cube is presented to provide a reference example of how a cube is used. It will be appreciated that the OLAP cubes maintained by various embodiments of the invention may have more or fewer dimensions than in this example, and that the OLAP cube may have more or fewer hierarchy levels than in this exemplary example.

Each data cell in a multidimensional database is uniquely identified by specifying a coordinate on each dimension. In order to uniquely identify a particular member within the OLAP cube, each of the members from the root node to the leaf node for the member is specified forming a tuple. A tuple may contain one or more members. According to one embodiment, each tuple contains the same number of members to access the desired data within the cube.

Queries to access different members within cube 300 may be consolidated. For example, the queries to access data within cell 310, cell 320, and cell 330 may be consolidated into a single query. Instead of accessing cube with three different database hits, a single database hit is incurred when the queries are consolidated.

Free-Form Reports and Structured Reports

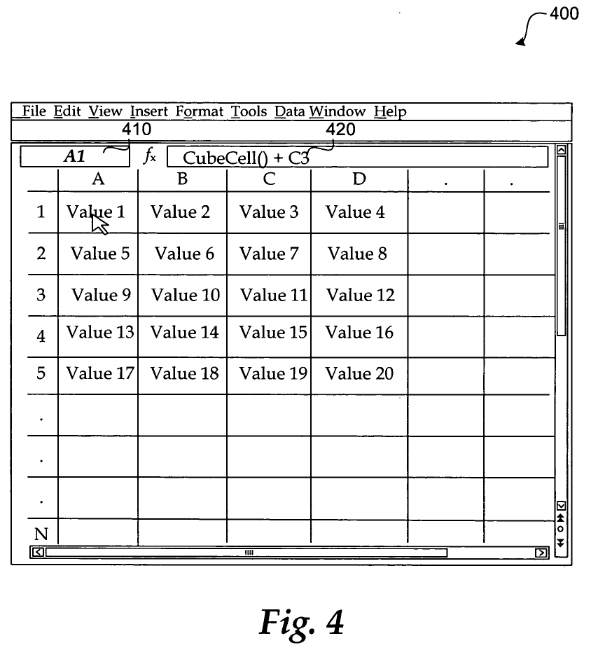

FIG. 4 illustrates a free-form report, in accordance with aspects of the invention.

A report consists of a connection to a data source, coupled with a layout that organizes the data values. The layout can be structured or free-form. Many aspects of report layout and member selection are the same between structured and free-form reports.

Unlike a structured report, free-form reports do not use structured report segments and a data grid. In a free-form report individual cell formulas connect each cell to the connection. Row, column, and page cells retrieve dimension member names from the connection. Data cells retrieve values. Report cells do not need to form a contiguous block. Formulas may be placed anywhere within the worksheet. For example, formulas may be placed into the middle of the report and rows and columns can be inserted or individual cells moved freely on the worksheet. Using free-form reports mixed hierarchies can be arranged in a single report axis making it easy to create asymmetrical reports. A single report can also integrate members and values from multiple connections, including cubes from different servers.

A structured report, on the other hand, does not allow changes to the worksheet. A free-form report contains individual cells, each of which may contain an independent function that accesses a value within a cube. Because each cell contains an independent function, a user is allowed to move cells around, insert rows and columns, interleave formulas, or any number of combinations.

As illustrated in report 400, each value within the report may include a formula. For example, cell A1 (see 410) contains the formula: CubeCellValue( )+C3 (420). One or more of the cells may access cube data. According to one embodiment of the invention, each cell within the report containing a value is parsed to determine if it accesses data within a cube. In this particular example, each cell within the first five rows (1-5) and first five columns (A-D) would be checked. A consolidated query is created that retrieves the data from a cube for at least two cells within the report. According to one embodiment, the consolidated query retrieves the data from a cube for all of the cells that access cube data.

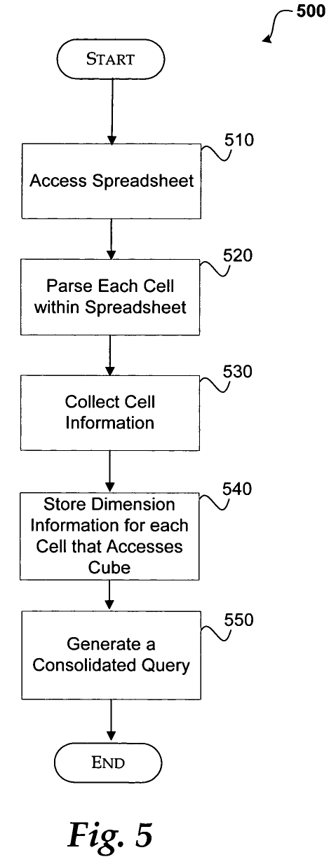

FIG. 5 illustrates a process for consolidating a query, in accordance with aspects of the present invention. After a start block, the process flows to block 510, where the free-form report in the spreadsheet is accessed. Moving to block 520, each of the cells within the spreadsheet is parsed. At block 530, cell information is collected from each cell. Generally, collecting the cell information includes determining when the cell accesses information from an OLAP cube. When the cell includes a function or value that is to be retrieved from an OLAP cube then the dimension information identifying the member(s) is stored at block 540. For example, one cell may access information from a first dimension and a second dimension within a cube and another cell within the spreadsheet may access information from the second dimension and a third dimension. Moving to block 550, each of the dimensions identifying the members to retrieve from the cube are formed into a consolidated query.

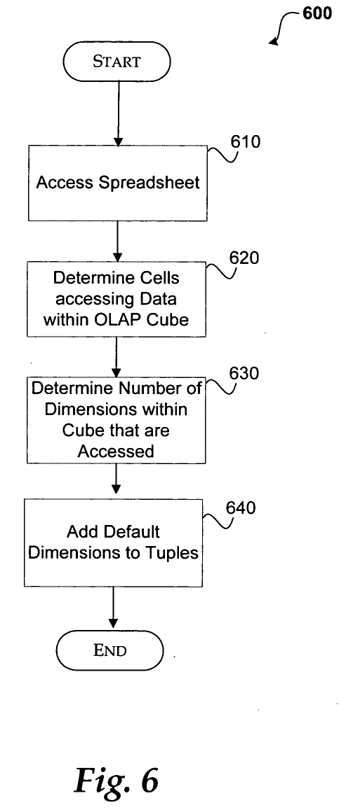

FIG. 6 illustrates a process for creating tuples to identify data within an OLAP cube, in accordance with aspects of the present invention. After a start block, the process flows to block 610 where the spreadsheet is accessed. Moving to block 620 each cell within the spreadsheet accessing data within an OLAP cube is determined. Flowing to block 630, each unique dimension accessed by cells within the spreadsheet is determined. Next, at block 640, default dimensions are added to each cells tuple to identify the data within the cube. For example, when four dimensions are accessed within the OLAP cube as determined at block 630, then each tuple identifying data within the cube will contain four dimensions. When three dimensions are accessed, then each tuple contains three dimensions.

Illustrative Operating Environment

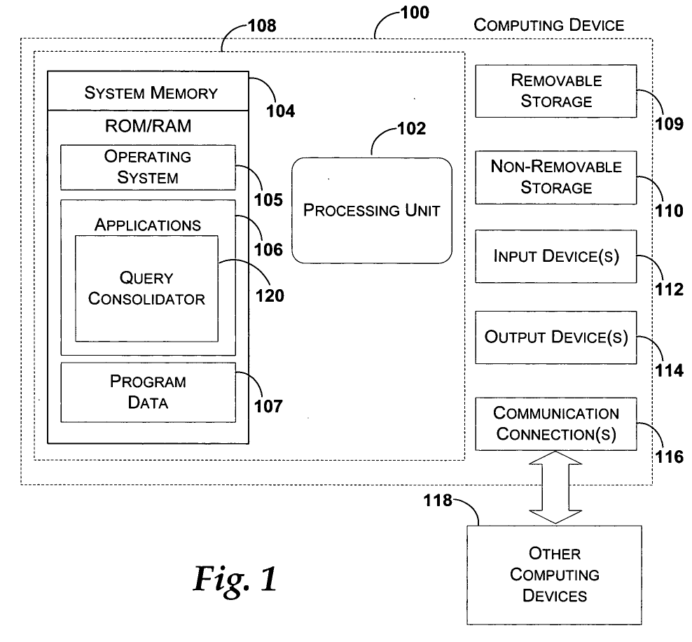

With reference to FIG. 1, one exemplary system for implementing the invention includes a computing device, such as computing device 100. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 105, one or more applications 106, and may include program data 107. In one embodiment, application 106 may include query consolidator 120. This basic configuration is illustrated in FIG. 1 by those components within dashed line 108.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included.

Computing device 100 may also contain communication connections 116 that allow the device to communicate with other computing devices 118, such as over a network. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer implemented method for optimizing OLAP queries, comprising:
accessing cells within a spreadsheet that reference data within an OLAP cube;
determining dimension information for each of the cells, wherein the dimension information relates to a position in the OLAP cube; and
consolidating each of the dimensions to create a consolidated query such that the consolidated query combines at least two of the cells dimension information.

2. The method of claim 1, wherein the consolidated query combines the dimension information for each of the cells into a single query.

3. The method of claim 2, further comprising sending the single query to an OLAP service.

4. The method of claim 3, further comprising receiving a response from the OLAP service and updating each cell within the spreadsheet with the information retrieved.

5. The method of claim 1, wherein accessing the cells within the spreadsheet that reference data within an OLAP cube comprises parsing each cell within the spreadsheet containing a formula to determine whether the cell requires data from the OLAP cube.

6. The method of claim 1, wherein the spreadsheet comprises a free-form report, wherein the free form report allows formulas within each of the cells.

7. The method of claim 6, wherein generating the dimension information further comprises determining the dimensions in each cell of the free-form report and generating a tuple that contains members from each dimension.

8. A computer-readable medium having computer executable instructions for optimizing OLAP queries, comprising:
accessing a spreadsheet containing cells;
parsing each cell within the spreadsheet to determine the cells that reference data within an OLAP cube;
generating dimension information for each of the cells that reference data within the OLAP cube, wherein the dimension information relates to a position in the OLAP cube; and
consolidating each of the generated dimensions to create a consolidated query.

9. The computer-readable medium of claim 8, wherein the consolidated query combines the dimension information for at least two cells that reference data within the OLAP cube.

10. The computer-readable medium of claim 9, further comprising: using the consolidated query to request data from the OLAP cube.

11. The computer-readable medium of claim 10, further comprising receiving the data from the OLAP cube and updating each cell within the spreadsheet with the data retrieved from the OLAP cube.

12. The computer-readable medium of claim 8, wherein parsing each cell within the spreadsheet to determine the cells that reference data within an OLAP cube comprises determining when the cell includes a reference to OLAP cube data.

13. The computer-readable medium of claim 8, wherein the spreadsheet comprises a free-form report, wherein the free-form report allows formulas within each of the cells.

14. The computer-readable medium of claim 13, wherein generating the dimension information further comprises determining the dimensions in each cell of the free-form report and generating a tuple that contains members from each dimension.

15. A system for optimizing OLAP queries, comprising:
an OLAP cube;
a spreadsheet containing cells, wherein at least two of the cells reference data within the OLAP cube; and a
a query consolidator configured to:
accessing cells within a spreadsheet that reference data within an OLAP cube;
determine dimension information for each of the cells, wherein the dimension information relates to a position in the OLAP cube; and
consolidating each of the generated dimensions to create a consolidated query such that the consolidated query combines at least two of the cells dimension information.

16. The system of claim 15, wherein the consolidated query combines the dimension information for each of the cells into a single query.

17. The system of claim 16, further comprising: sending the single query to an OLAP service.

18. The system of claim 17, further comprising receiving a response from the OLAP service and updating each cell within the spreadsheet with the information retrieved.

19. The system of claim 15, wherein accessing the cells within the spreadsheet that reference data within an OLAP cube comprises parsing each cell within the spreadsheet containing a formula to determine whether the cell requires data from the OLAP cube.

20. The system of claim 15, wherein the spreadsheet comprises a free-form report, wherein the free form report allows formulas within each of the cells.

21. The system of claim 20, wherein generating the dimension information further comprises determining the dimensions in each cell of the free-form report and generating a tuple that contains members from each dimension.
